(19) United States
(12) Patent Application Publication
(10) Pub. No.: US 2025/0143380 A1
(43) Pub. Date: May 8, 2025

(54) HEAT-NOT-BURN SMOKING DEVICE, ELECTROMAGNETIC INDUCTION HEATING CONTROL METHOD AND CONTROL DEVICE

(71) Applicant: DONGGUAN MYSMOK ELECTRONIC TECHNOLOGY CO., LTD, Dongguan (CN)

(72) Inventors: Liqing He, Dongguan (CN); Xiaoxia Ai, Dongguan (CN)

(21) Appl. No.: 19/004,528

(22) Filed: Dec. 30, 2024

(30) Foreign Application Priority Data
Sep. 12, 2024 (CN) 202411277244.4

(51) Int. Cl. A24F 40/57; A24F 40/20; A24F 40/465; H02M 1/00; H02M 7/48

(52) U.S. Cl. CPC A24F 40/57; A24F 40/465; H02M 1/0009; H02M 7/4815; A24F 40/20

(57) ABSTRACT

The electromagnetic induction heating control method includes supplying the driving circuit with the excitation source with an initial frequency at a first duty cycle to initiate operation of the resonant network, the first duty cycle being less than 50%; and collecting a working current of the resonant network in real time, adjusting the input frequency of the excitation source within a preset frequency range to find a maximum working current, setting the input frequency at the maximum working current as an optimal input frequency, and adjusting the input frequency of the excitation source to the optimal input frequency. In such a way, the working frequency is adjusted close to the resonant frequency of the resonant network, thereby ensuring that the resonant network works in a resonant state, and ensuring high heating stability.

### CROSS REFERENCE TO RELATED APPLICATIONS

The present application claims the benefit of Chinese Patent Application No. 202411277244.4 filed on Sep. 12, 2024, the contents of which are incorporated herein by reference in their entirety.

### FIELD OF THE INVENTION

The present invention relates to heat-not-burn smoking devices, particularly to a control method and control device of electromagnetic induction heating for heat-not-burn smoking devices.

### BACKGROUND OF THE INVENTION

Traditional heat-not-burn smoking devices typically heat the cigarette by using metal resistance wires, thick-film heating, thin-film heating, or ceramic heaters. In use, the heater is inserted into the cigarette, and then the device is activated to heat the cigarette. The device detects changes in the resistance of the heater to perform closed-loop temperature control. Such a heat-not-burn smoking device often has a relatively short service life.

To address the above shortcomings, the new generation of heat-not-burn smoking devices has adopted electromagnetic induction heating technology, where the electromagnetic heating coil of the electromagnetic sending device sends high-frequency AC signals to the heating metal induction element. The metal induction element, in a changing magnetic field or moving in a non-uniform magnetic field, will generate an induced electromotive force. Since the resistance of the metal is very small, even if the induced electromotive force is not large, it can cause a strong current. This results in a thermal effect that heats the aerosol generating product. Such aerosol generating products generally include a power control module, a heating component, and a heating chamber. The power control module provides high-frequency AC signals to the heating component, and the heating chamber is used to accommodate the cigarette cartridge. The heating component includes an electromagnetic heating coil that surrounds the heating chamber, and the induced metal induction element is installed inside the heating chamber or directly in the cigarette cartridge.

A conventional power control module is a Class E resonant topology high-frequency inverter circuit, including a driving circuit and a resonant network. The driving circuit includes an inductor, a capacitor, and a MOS transistor. The resonant network includes a capacitor and an inductor. The driving circuit converts the power supply into a high-frequency power signal based on the excitation source input to the MOS transistor to drive the resonant network to generate a high-frequency sine wave signal. The metal induction element senses this high-frequency sine wave signal and heats up to heat the cigarette. During operation, the control unit sends an excitation source with a fixed frequency to the MOS transistor to control the driving circuit to generate a power signal with a fixed frequency. When adjusting the metal induction element, it is only necessary to adjust the duty cycle of the excitation source Fin based on the sensed load resistance or working current. To ensure stable heating, a frequency close to the resonant frequency of the resonant network is preferably chosen as the frequency of the excitation source. The frequency of the resonant network is determined by the inductance (denoted by L2) and the capacitance (denoted by C2)

$$\frac{1}{2 π \sqrt{L 2 * C 2}} ,$$

hence the excitation source denoted by Fp is calculated:

$$F p = \frac{1}{2 π \sqrt{L 2 * C 2}} ,$$

where L2 and C2 are fixed values.

However, due to the following reasons, it is inevitable that the frequency of the actual excitation source will deviate from the frequency of the resonant network.

First, the inductance of the inductor component usually changes with the increase of temperature. For coil-type inductors, as the temperature rises, the resistance of the coil increases, leading to a decrease in inductance. This is caused by the temperature effect on the wire of the coil. For core-type inductors, as the temperature rises, the permeability of the core changes, leading to changes in inductance.

Second, the capacitance of the capacitor component usually changes with the increase of temperature. This is because the dielectric constant and the tangent of the dielectric loss angle of the capacitive material change with temperature. For aluminum electrolytic capacitors, an increase in temperature leads to an increase in the conductivity of the electrolyte, leading to an increase in capacitance value. For ferroelectric medium capacitors, an increase in temperature leads to changes in the polarization effect of the ferroelectric material, leading to changes in capacitance value.

Third, the inductor and capacitor components have manufacturing errors.

Therefore, in the existing heat-not-burn smoking devices, it is difficult to make the resonant network work in an ideal resonant state, resulting in poor heating stability.

Thus, there is an urgent need for a heating control method for heat-not-burn smoking devices that can solve the above problems.

### SUMMARY OF THE INVENTION

The purpose of the present invention is to provide an electromagnetic induction heating control method, a control device, and a heat-not-burn smoking device that can calibrate the working frequency of the excitation source before formally heating the cigarette to make the working frequency close to the resonant frequency of the resonant network, thereby ensuring that the resonant network works in a resonant state, and ensuring high heating stability.

In order to realize the above purpose, the invention provides an electromagnetic induction heating control method for a heat-not-burn smoking device. The heat-not-burn smoking device includes a driving circuit and a resonant network, the driving circuit converts a direct current power supply into a high-frequency power signal based on an excitation source that is input so as to drive the resonant network to generate a high-frequency sine wave signal, and a metal induction element heats up by sensing the high-frequency sine wave signal. The method includes steps for calibrating an input frequency of the excitation source: supplying the driving circuit with the excitation source with an initial frequency at a first duty cycle to initiate operation of the resonant network, the first duty cycle being less than 50%; and collecting a working current of the resonant network in real time, adjusting the input frequency of the excitation source within a preset frequency range to find a maximum working current, setting the input frequency at the maximum working current as an optimal input frequency, and adjusting the input frequency of the excitation source to the optimal input frequency.

Preferably, the first duty cycle is greater than or equal to 1% and less than or equal to 15%.

Preferably, the input frequency of the excitation source is calibrated based on external control commands, and/or at each time the device is powered on, and/or at first time the device is powered on, and/or once after the device is powered on for preset multiple times.

Preferably, after obtaining the optimal input frequency, the method further includes recording the optimal input frequency, and setting the optimal input frequency as the initial frequency for the excitation source during a next power-on and calibration.

Preferably, the preset frequency range is from 5 MHz to 7 MHz.

Preferably, after finding the maximum working current, the method further includes determining whether the maximum working current is within the preset current range; if yes, setting the input frequency at the maximum working current as the optimal input frequency; if not, outputting a fault signal and/or re-calibrating the input frequency of the excitation source until the optimal input frequency is within the preset current range, or the calibration attempts exceed a preset number, or the calibration time exceeds the preset duration, and then outputting the fault signal and shutting off a power supply to the resonant network.

Preferably, before calibrating the input frequency of the excitation source, the method further includes detecting and obtaining a current temperature of the metal induction element, starting a calibration of the input frequency of the excitation source when the current temperature is below a preset temperature, and stopping the calibration when the current temperature exceeds the preset temperature.

Specifically, the preset current range is from 2.5 A to 4.5 A. The preset current is set according to the theoretical optimal working current, and the theoretical optimal working current is generally in the middle of the preset current range or near the middle of the preset current range. Of course the preset current range is not limited to the above values. The theoretical optimum working current can be obtained by experimental test or by theoretical calculation formula.

Preferably, the method further includes adjusting a current input frequency in a first direction, if the working current increases, continuing adjusting until the working current begins to decrease to determine the maximum working current; if the working current decreases, adjusting the current input frequency in a second direction opposite to the first direction, if the working current increases, continuing adjusting until the working current begins to decrease to determine the maximum working current, if the working current still decreases, setting an initial working current as the maximum working current.

Preferably, after calibrating the input frequency of the excitation source, the method further includes adjusting a duty cycle of the excitation source to a second duty cycle to rapidly heat the metal induction element, and the first duty cycle is less than the second duty cycle. In such a way, the heat-not-burn smoking device can work after the input frequency of the excitation source is calibrated.

Preferably, the second duty cycle is greater than or equal to 90% and less than or equal to 98%.

Preferably, after adjusting the duty cycle of the excitation source to the second duty cycle, the method further includes adjusting the duty cycle of the excitation source to maintain the metal induction element at a target temperature.

More specifically, the method further includes after adjusting the duty cycle of the excitation source to the second duty cycle, finding a first current I₁ at an inflection point of a first valley where the working current changes, and obtaining the second current I₂ at the inflection point of a second peak where the working current changes; determining the target current based on the first current I₁ and the second current I₂, where the target current is greater than the first current I₁ and less than the second current I₂; and adjusting the duty cycle of the excitation source based on the target current.

The present invention further provides an electromagnetic induction heating control device for a heat-not-burn smoking device, including a current acquisition circuit for acquiring a working current of an electromagnetic generation device, one or more processors, a memory, and one or more programs. The one or more programs are stored in the memory and are configured to be executed by the one or more processors to implement the electromagnetic induction heating control method for a heat-not-burn smoking device as mentioned above.

The present invention further provides a heat-not-burn smoking device, including a power supply, a driving circuit, a resonant network, and a control module. The power supply outputs a direct current, the control module controlling a duty cycle of the excitation source of the driving circuit, the driving circuit converts the direct current into an alternating current power signal based on the excitation source, the resonant network generates high-frequency electromagnetic waves based on the alternating current power signal, and the metal induction element heats up by sensing the high-frequency electromagnetic waves to heat a cigarette. The control module includes an acquisition circuit and a control unit, the acquisition circuit is configured to acquire a working current of the resonant network, and the control unit is configured to supply the driving circuit with an excitation source with an initial frequency at a first duty cycle to initiate operation of the resonant network, the first duty cycle is less than 50%, the input frequency of the excitation source is adjusted within a preset frequency range to find a maximum working current, and the input frequency at the maximum working current is set as an optimal input frequency, and the input frequency of the excitation source is adjusted to the optimal input frequency.

Compared to the prior art, the heat-not-burn smoking device according to the present invention is operated at a relatively low duty cycle before starts working, and the frequency of the excitation source is adjusted when the metal induction element is at a low temperature, thereby preventing the metal induction element from overheating and affecting the detection results.

Furthermore, by finding the optimal working current, the optimal input frequency of the excitation source is obtained, and the frequency of the excitation source is adjusted as close as possible to the resonant frequency of the resonant network, thereby solving the issue of the resonant frequency of the resonant network deviating from the working frequency of the excitation source due to long-term use and errors of the components themselves, ensuring that the resonant network works in a resonant state, and making the circuit close to a pure resistive working state and having improved heating stability.

### BRIEF DESCRIPTION OF THE DRAWINGS

FIG. 1 is a circuit diagram of a heat-not-burn smoking device of the present invention.

FIG. 2 is a flowchart of the electromagnetic induction heating control method according to a first embodiment of the present invention.

FIG. 3 is a flowchart of the electromagnetic induction heating control method according to a second embodiment of the present invention.

FIG. 4 is a flowchart of the electromagnetic induction heating control method according to a third embodiment of the present invention.

FIG. 5 is a structural diagram of the heat-not-burn smoking device of the present invention.

### DETAILED DESCRIPTION OF ILLUSTRATED EMBODIMENTS

To provide a detailed explanation of the technical content, structural features, objectives, and effects achieved by the present invention, the following description is provided in conjunction with the embodiments and the accompanying drawings.

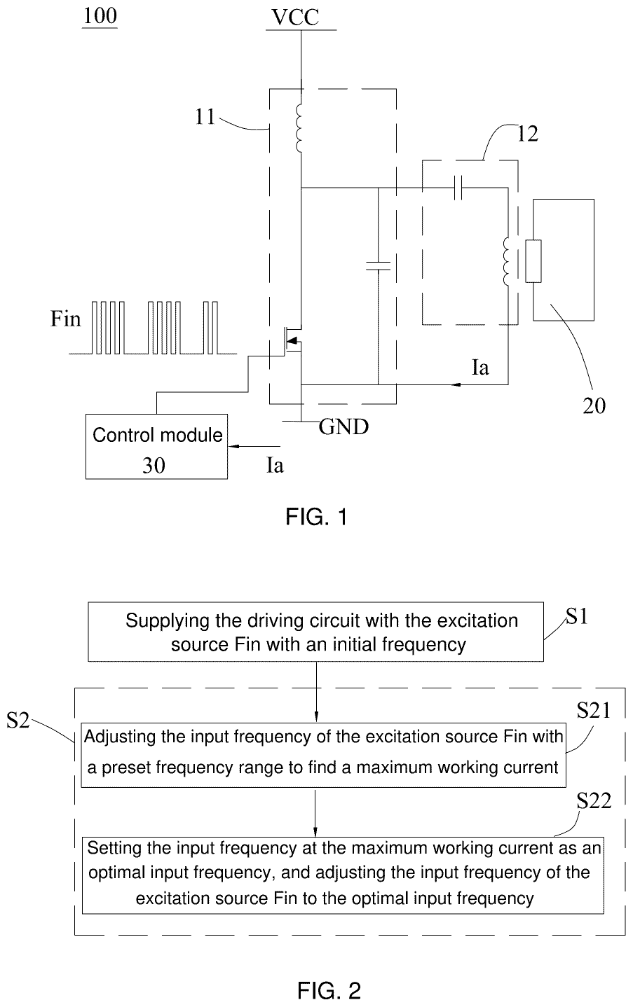

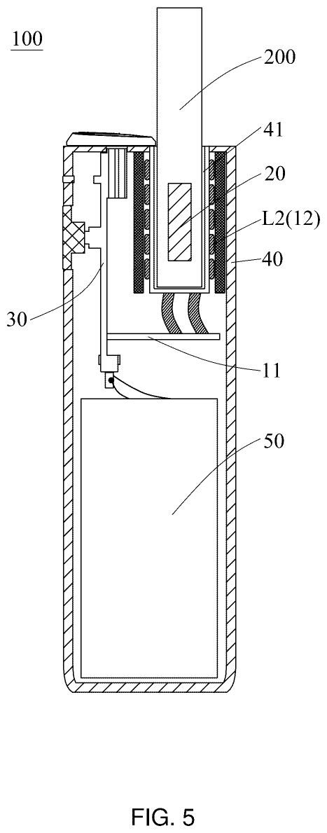

Referring to FIGS. 1 and 5, the present invention discloses a heat-not-burn smoking device 100, which includes a direct current (DC) power supply VCC, a driving circuit 11, a resonant network 12, and a control module 30. The power supply VCC outputs a DC power, and the control module 30 controls the duty cycle and the input frequency of the excitation source Fin of the driving circuit 11. The driving circuit 11 converts the DC power into an alternating current (AC) power signal based on the excitation source Fin, and the resonant network 12 generates high-frequency electromagnetic waves based on the power signal. The metal induction element 20 senses the high-frequency electromagnetic waves and begins to heat up to heat the cigarette 200. The metal induction element 20 can be installed in the heating chamber 41 of the heat-not-burn smoking device casing 40 or built into the cigarette 200, and it is located in the heating chamber 41 as the cigarette 200 is inserted.

Referring to FIG. 5, the heat-not-burn smoking device 100 further includes a battery 50, which is used to provide the power supply VCC.

Referring to FIG. 1, the control module 30 includes an acquisition circuit and a control unit. The acquisition circuit collects the working current Ia of the resonant network 12. The control unit, when calibrating the input frequency of the excitation source Fin, supplies the driving circuit 11 with an excitation source Fin with an initial frequency at a first duty cycle to initiate the operation of the resonant network 12 without rapidly heating the metal induction element 20. The control unit adjusts the input frequency of the excitation source Fin within a preset frequency range to find the maximum working current and sets the input frequency at the maximum working current as an optimal input frequency. The control unit then adjusts the input frequency of the excitation source Fin to the optimal input frequency, allowing the excitation source Fin to output at the optimal input frequency during operation, thereby completing the calibration of the input frequency of the excitation source Fin.

After completing the calibration of the input frequency of the excitation source Fin, the control unit can adjust the duty cycle of the excitation source Fin to a second duty cycle to rapidly heat the resonant network, and adjust the duty cycle of the excitation source Fin in real time to maintain the metal induction element 20 at the target temperature, where the first duty cycle is less than the second duty cycle.

Specifically, the control unit includes one or more processors, a memory, and one or more programs, where the one or more programs are stored in the memory and are configured to be executed by one or more processors to implement the electromagnetic induction heating control method.

In the first embodiment, referring to FIG. 2, the electromagnetic induction heating control method specifically includes steps for calibrating the input frequency of the excitation source Fin, as described in the following steps S1 to S2.

S1, supplying the driving circuit 11 with the excitation source with an initial frequency at a first duty cycle to initiate operation of the resonant network, the first duty cycle being less than 50%.

If the metal induction element 20 is built into the cigarette 200, the calibration of the input frequency of the excitation source Fin begins after the cigarette 200 is inserted into the heating chamber 41 of the heat-not-burn smoking device to avoid the device being in a no-load condition during calibration. That is to say, after powering on, the calibration of the input frequency of the excitation source Fin will be initiated only when the cigarette 200 is detected to be inserted into the heat-not-burn smoking device, and the driving circuit 11 will be supplied with an excitation source Fin with an initial frequency at a first duty cycle. If the metal induction element 20 is installed in the heating chamber 41 of the heat-not-burn smoking device and the cigarette 200 does not contain the metal induction element 20, the calibration of the input frequency of the excitation source Fin can be initiated after the cigarette 200 is inserted into the heating chamber 41 or can be initiated directly. If the cigarette 200 is not inserted into the heating chamber 41, the power supply to the induction network is stopped (that is, the DC power supply is disconnected or the duty cycle is adjusted to 0) after the calibration of the input frequency of the excitation source Fin is complete. If the cigarette 200 is inserted into the heating chamber 41, after the calibration of the input frequency of the excitation source Fin is complete, the device directly operates to increase the duty cycle to the second duty cycle so as to heat the cigarette 200. At this time, the control module 30 supplies the driving circuit 11 with an excitation source Fin with a duty cycle of the second duty cycle and a frequency of the optimal input frequency.

In this embodiment, the first duty cycle is greater than or equal to 1% and less than or equal to 15%.

The value of this first duty cycle is chosen so that the resonant network 12 starts working but does not effectively heat the metal induction element 20, or in other words, prevents the metal induction element 20 from reaching a preset temperature within a preset time, for example, not reaching 100° C. within 1 second.

Step S2 includes following sub-steps: S21, adjusting the input frequency of the excitation source Fin within a preset frequency range to find a maximum working current, and S22, setting the input frequency at the maximum working current as an optimal input frequency, and adjusting the input frequency of the excitation source Fin to the optimal input frequency, thereby allowing the excitation source Fin to output at the optimal input frequency.

The preset frequency range is 5 MHz to 7 MHz. Other range values can be chosen as needed, which are not limited to the above range. This preset frequency range is set around the ideal resonant frequency of the resonant network 12, and in this embodiment, the ideal resonant frequency of the resonant network 12 is 6 MHz.

Step S21 specifically includes adjusting the current input frequency in a first direction, if the working current Ia increases, continuing adjusting the current input frequency until the working current Ia begins to decrease to determine a maximum working current; if the working current Ia decreases, adjusting the current input frequency in a second direction opposite to the first direction, if the working current Ia increases then continuing adjusting the current input frequency until the working current Ia begins to decrease to determine the maximum working current, if the working current Ia still decreases, setting the initial working current as the maximum working current. The first direction can be the direction of gradually reducing the input frequency or the direction of gradually increasing the input frequency.

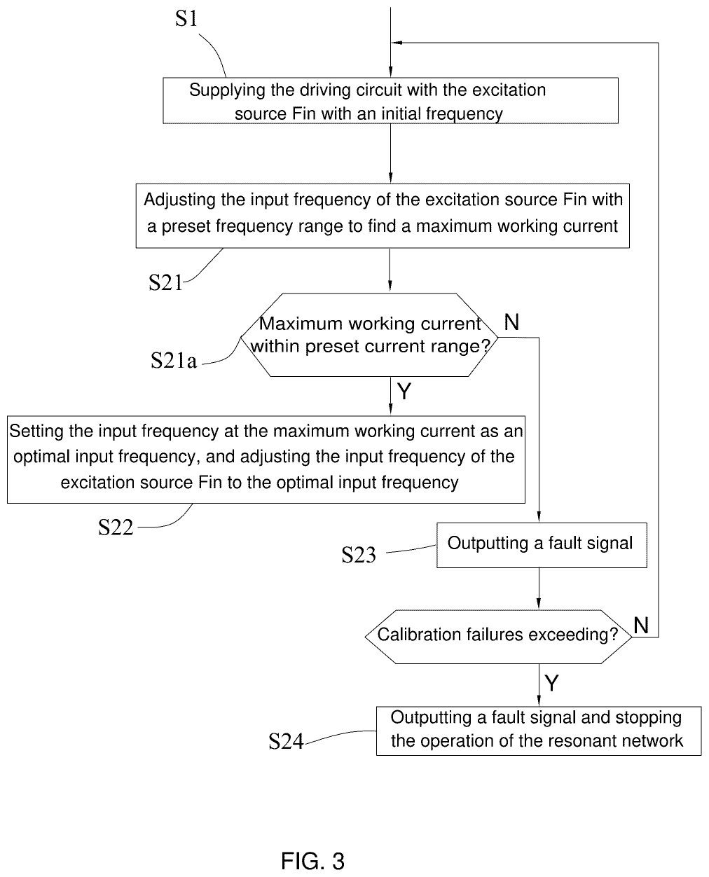

Referring to FIG. 3, based on the first embodiment, the second embodiment further includes the following steps after step S21: S21a, determining whether the maximum working current is within the preset current range, if yes, setting the input frequency at the maximum working current as an optimal input frequency, if not, performing step S23, outputting a fault signal. Additionally, the calibration may be restarted while the fault signal is outputted. If the number of failures exceeds a preset number or the entire calibration time exceeds a preset duration, then step S24 is performed, outputting a fault signal and stopping the operation of the resonant network 12. The preset current range is from 2.5 A to 4.5 A. Other range values can be chosen as needed, which are not limited to the above range. This preset current range is set around an optimal working current, and in this embodiment, the optimal working current is 3.6 A. In theory, when the temperature of the metal induction element 20 has not entered the high-temperature range, or the calibration is initiated from room temperature, then at the excitation source with the current duty cycle, the optimal working current corresponding to the ideal resonant frequency of the resonant network 12 is 3.6 A. It's seen that, the preset current range is set around the optimal working current. The range boundary is generally affected by the conventional capacitors, the aging deviation and manufacturing error sizes of the inductors, and is the maximum range values at the longest calibration setting time (preset duration) under the above conditions. It can be an estimated value or a set value obtained from actual measurements. The preset number may be two or three, or greater than two, etc., and the preset duration may be 1 second or 2 seconds.

Preferably, in the electromagnetic induction heating control method, the input frequency of the excitation source is calibrated based on external control commands, and/or the input frequency of the excitation source is calibrated at each time the device is powered on, and/or the input frequency of the excitation source is calibrated at first time the device is powered on, and/or the input frequency of the excitation source is calibrated once after the device is powered on for preset multiple times.

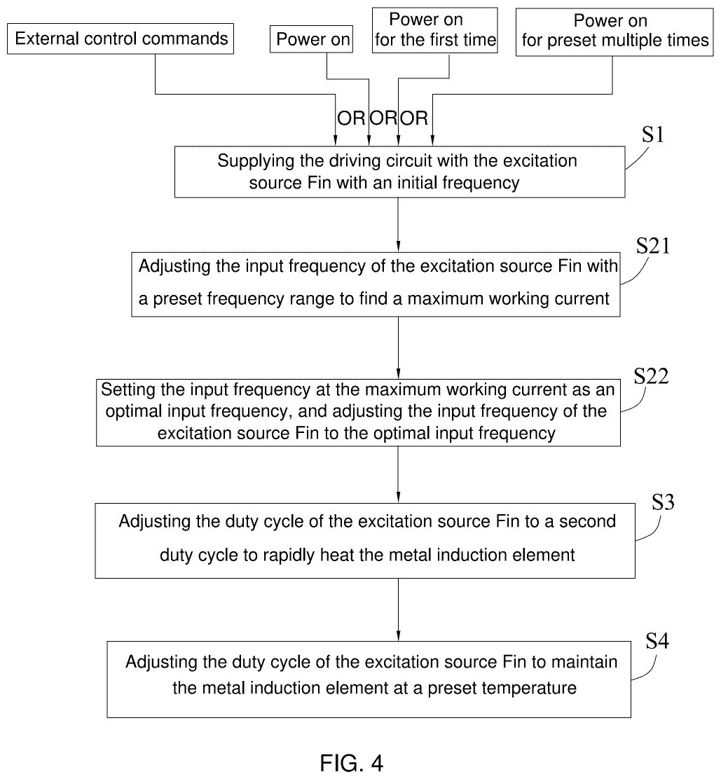

Reference to FIG. 4, based on the first and second embodiments, the third embodiment further includes steps S3 to S4.

S3, adjusting the duty cycle of the excitation source Fin to a second duty cycle to rapidly heat the metal induction element 20. At this time, the excitation source Fin is input to the control end of the driving circuit 11 with the second duty cycle and the optimal input frequency, where the first duty cycle is less than the second duty cycle.

This step allows the heat-not-burn smoking device to continuously heat the metal induction element 20 to heat the cigarette 200 without interruption after calibration, that is to say, the calibration is performed before use.

The electromagnetic induction heating control method further includes step S4: adjusting the duty cycle of the excitation source Fin to maintain the metal induction element 20 at a preset temperature.

Step S4 specifically includes the following sub-steps:
finding a first current I₁ at an inflection point of a first valley where the working current changes;
obtaining the second current I₂ at the inflection point of a second peak where the working current changes;
determining the target current based on the first current I₁ and the second current I₂, where the target current is greater than the first current I₁ and less than the second current I₂;
adjusting the duty cycle of the excitation source based on the target current.

Specifically, the main metal components of the metal induction element 20 are iron and nickel, which have the first Curie temperature T_{C1} of nickel and the second Curie temperature T_{C2} of iron. The main metals of the metal induction element 20 also may be multiple metal elements such as iron, nickel, chromium, manganese, cobalt, etc. The two metal elements with content greater than a preset range that can significantly affect the magnetic resistance Rm of the entire metal induction element 20 are selected as the main metal components, and the Curie temperatures of these two main metal components are used as the first Curie temperature T_{C1} and the second Curie temperature T_{C2}.

The working temperature of the metal induction element 20 is controlled between the first Curie temperature T_{C1} and the second Curie temperature T_{C2}. During the temperature control, the larger the working current Ia, the higher the temperature, and the smaller the magnetic resistance of the metal induction element 20.

The coefficients k and constant b of the temperature-current linear equation between the first Curie temperature T_{C1} and the second Curie temperature T_{C2} of the metal induction element 20 are calculated based on the preset first Curie temperature T_{C1}, the preset second Curie temperature T_{C2}, the first current I₁, and the second current I₂. The target temperature T_{d} of the metal induction element 20 is calculated based on the temperature-current linear equation, and the corresponding working current IaI_{d} is used as the target current, where the target temperature Ta is greater than the first Curie temperature T_{C1} and less than the second Curie temperature T_{C2}.

Preferably, step of determining the target current based on the first current I₁ and the second current I₂ specifically includes taking the weighted average of the first current value I₁ and the second current value I₂ as the target current Ia. For example, the target current Id=eI₁+fI₂, where e and f are constants, e+f=1, and f is greater than or equal to 10% and less than or equal to 50%.

Optionally, step S4 can directly use the preset target temperature and the relationship between the working current Ia to adjust the duty cycle, and adjust the working current Ia to the target current. When the working current Ia is greater than the target current, it's necessary to reduce the duty cycle of the excitation source Fin; when the working current Ia is less than the target current, it's necessary to increase the duty cycle of the excitation source Fin.

Preferably, to further improve the calibration stability for the input frequency of the excitation source, before step S1 (i.e. calibration), the method further includes detecting and obtaining the current temperature of the metal induction element (by determining the current load resistance, or by a temperature sensor). The calibration of the input frequency of the excitation source Fin is initiated when the current temperature does not exceed the preset temperature value, and is stopped calibration when the current temperature exceeds the preset temperature value, with an overheating prompt provided. The preset temperature value can be selected as 80° C. Since the temperature of the metal induction element affects its impedance, the load resistance (the resistance of the metal induction element) can be used to determine the current temperature. Since the duty cycle at startup is the preset first duty cycle and the DC power is the preset DC power, the current working current is mainly affected by the excitation source frequency and load resistance. The input frequency of the excitation source will not deviate too far from the theoretical resonant frequency of the resonant network, so the working current can generally reflect the temperature of the metal induction element. Therefore, it is possible to determine whether the metal induction element has exceeded the preset temperature by determining whether the current working current exceeds the preset current range corresponding to the preset temperature; if it exceeds, it is determined that the current temperature of the metal induction element has exceeded the preset temperature value. This method can reduce the ineffective calibration of the excitation source.

Preferably, when the temperature exceeds the preset temperature value and calibration is stopped with an overheating prompt provided, the calibration for the input frequency of the excitation source Fin can be skipped and the next operation can be directly performed, such as step S3: controlling the resonant network 12 to start working with the second duty cycle and the current input frequency (initial frequency) of the excitation source Fin to rapidly heat the metal induction element 20.

Optionally, temperature detection and judgment can also be omitted before calibration. For example, by judging the maximum working current, the metal induction element can be determined to be overheated or the drive circuit of the heat-not-burn smoking device can determined to be out of frequency fault.

The control module 30 is further configured to record the optimal input frequency and set the optimal input frequency as the initial frequency for the next power-on and calibration. That is to say, step S22 further includes recording the optimal input frequency and setting the optimal input frequency as the initial frequency for the next power-on and calibration.

Compared to the prior art, the heat-not-burn smoking device 100 according to the present invention is operated at a relatively low duty cycle before starts working, and the frequency of the excitation source Fin is adjusted as close as possible to the resonant frequency of the resonant network 12, thereby solving the issue of the resonant frequency of the resonant network 12 deviating from the working frequency of the excitation source Fin due to long-term use and errors of the components themselves, ensuring that the resonant network 12 works in a resonant state, and making the circuit close to a pure resistive working state and having improved heating stability.

In the present invention, when the heat-not-burn smoking device 100 needs calibration, after power-on, the duty cycle of the excitation source Fin is changed as follows: the first duty cycle→the second duty cycle→the third duty cycle controlled by real-time feedback according to the target temperature of the metal induction element, and the range of the third duty cycle floats as needed, generally below the second duty cycle.

The above embodiments are provided for a detailed description of the technical solution of the present application, but the description of these embodiments is only for facilitating understanding of the methods disclosed herein and should not be construed as limitations on the embodiments of the present application. Variations or replacements readily apparent to those skilled in the art in this technical field should be encompassed within the protection scope of the present application.

What is claimed is:

1. An electromagnetic induction heating control method for a heat-not-burn smoking device, the heat-not-burn smoking device comprising a driving circuit and a resonant network, the driving circuit converting a direct current power supply into a high-frequency power signal based on an excitation source that is input so as to drive the resonant network to generate a high-frequency sine wave signal, a metal induction element heating up by sensing the high-frequency sine wave signal, wherein the method comprising steps for calibrating an input frequency of the excitation source:
supplying the driving circuit with the excitation source with an initial frequency at a first duty cycle to initiate operation of the resonant network, the first duty cycle being less than 50%; and
collecting a working current of the resonant network in real time, adjusting the input frequency of the excitation source within a preset frequency range to find a maximum working current, setting the input frequency at the maximum working current as an optimal input frequency, and adjusting the input frequency of the excitation source to the optimal input frequency.

2. The method as claimed in claim 1, wherein the first duty cycle is greater than or equal to 1% and less than or equal to 15%.

3. The method as claimed in claim 1, wherein the input frequency of the excitation source is calibrated based on external control commands, and/or at each time the device is powered on, and/or at first time the device is powered on, and/or once after the device is powered on for preset multiple times.

4. The method as claimed in claim 1, after obtaining the optimal input frequency, further comprising recording the optimal input frequency, and setting the optimal input frequency as the initial frequency for the excitation source during a next power-on and calibration.

5. The method as claimed in claim 1, wherein the preset frequency range is from 5 MHz to 7 MHz.

6. The method as claimed in claim 1, after finding the maximum working current, further comprising determining whether the maximum working current is within the preset current range; if yes, setting the input frequency at the maximum working current as the optimal input frequency; if not, outputting a fault signal and/or re-calibrating the input frequency of the excitation source until the optimal input frequency is within the preset current range, or the calibration attempts exceed a preset number, or the calibration time exceeds the preset duration, and then outputting the fault signal and shutting off a power supply to the resonant network.

7. The method as claimed in claim 6, wherein the preset current range is from 2.5 A to 4.5 A.

8. The method as claimed in claim 1, before calibrating the input frequency of the excitation source, further comprising detecting and obtaining a current temperature of the metal induction element, starting a calibration of the input frequency of the excitation source when the current temperature is below a preset temperature, and stopping the calibration when the current temperature exceeds the preset temperature.

9. The method as claimed in claim 1, wherein the step of adjusting the excitation source input frequency within the preset frequency range to find the maximum working current comprising: adjusting a current input frequency in a first direction, if the working current increases, continuing adjusting until the working current begins to decrease to determine the maximum working current; if the working current decreases, adjusting the current input frequency in a second direction opposite to the first direction, if the working current increases, continuing adjusting until the working current begins to decrease to determine the maximum working current, if the working current still decreases, setting an initial working current as the maximum working current.

10. The method as claimed in claim 1, after calibrating the input frequency of the excitation source, further comprising adjusting a duty cycle of the excitation source to a second duty cycle to rapidly heat the metal induction element, wherein the first duty cycle is less than the second duty cycle.

11. The method as claimed in claim 10, wherein the second duty cycle is greater than or equal to 90% and less than or equal to 98%.

12. The method as claimed in claim 10, after adjusting the duty cycle of the excitation source to the second duty cycle, further comprising adjusting the duty cycle of the excitation source to maintain the metal induction element at a target temperature.

13. The method as claimed in claim 12, wherein adjusting the duty cycle of the excitation source to maintain the metal induction element at the target temperature specifically comprises:
after adjusting the duty cycle of the excitation source to the second duty cycle, finding a first current I₁ at an inflection point of a first valley where the working current changes, and obtaining the second current I₂ at the inflection point of a second peak where the working current changes; determining the target current based on the first current I₁ and the second current I₂, where the target current is greater than the first current I₁ and less than the second current I₂; and adjusting the duty cycle of the excitation source based on the target current.

14. An electromagnetic induction heating control device for a heat-not-burn smoking device, comprising:
a current acquisition circuit for acquiring a working current of an electromagnetic generation device;
one or more processors;
a memory; and
one or more programs, wherein the one or more programs are stored in the memory and are configured to be executed by the one or more processors to implement the electromagnetic induction heating control method for a heat-not-burn smoking device as claimed in claim 1.

15. A heat-not-burn smoking device, comprising a power supply, a driving circuit, a resonant network, and a control module, the power supply outputting a direct current, the control module controlling a duty cycle of the excitation source of the driving circuit, the driving circuit converting the direct current into an alternating current power signal based on the excitation source, the resonant network generating high-frequency electromagnetic waves based on the alternating current power signal, and the metal induction element heating up by sensing the high-frequency electromagnetic waves to heat a cigarette;
wherein the control module comprises an acquisition circuit and a control unit, the acquisition circuit is configured to acquire a working current of the resonant network, and the control unit is configured to supply the driving circuit with an excitation source with an initial frequency at a first duty cycle to initiate operation of the resonant network, the first duty cycle is less than 50%, the input frequency of the excitation source is adjusted within a preset frequency range to find a maximum working current, and the input frequency at the maximum working current is set as an optimal input frequency, and the input frequency of the excitation source is adjusted to the optimal input frequency.

16. The heat-not-burn smoking device as claimed in claim 15, wherein the control unit is configured to calibrate the input frequency of the excitation source based on external control commands, and/or at each time the device is powered on, and/or at first time the device is powered on, and/or once after the device is powered on for preset multiple times.

17. The heat-not-burn smoking device as claimed in claim 15, wherein the first duty cycle is greater than or equal to 1% and less than or equal to 15%.

18. The heat-not-burn smoking device as claimed in claim 15, wherein after calibrating the input frequency of the excitation source, the control unit further adjusts a duty cycle of the excitation source to a second duty cycle to rapidly heat the metal induction element, then finds a first current I₁ at an inflection point of a first valley where the working current changes, and obtains the second current I₂ at the inflection point of a second peak where the working current changes; determines the target current based on the first current I₁ and the second current I₂, where the target current is greater than the first current I₁ and less than the second current I₂; and adjusts the duty cycle of the excitation source based on the target current, where the first duty cycle is less than the second duty cycle.

19. The heat-not-burn smoking device as claimed in claim 15, wherein when the control unit finds the maximum working current, the control unit further determines whether the maximum working current is within the preset current range; if yes, the input frequency at the maximum working current is set as the optimal input frequency; if not, a fault signal and/or re-calibrating the input frequency of the excitation source is output until the optimal input frequency is within the preset current range, or the calibration attempts exceed a preset number, or the calibration time exceeds the preset duration, and then the fault signal is output, and a power supply to the resonant network is shut off.

20. The heat-not-burn smoking device as claimed in claim 15, wherein before calibrating the input frequency of the excitation source, the control unit further detects and obtains a current temperature of the metal induction element, and starts a calibration of the input frequency of the excitation source when the current temperature is below a preset temperature, and stops the calibration when the current temperature exceeds the preset temperature.
